(19) United States
(12) Patent Application Publication
(10) Pub. No.: US 2015/0184594 A1
(43) Pub. Date: Jul. 2, 2015

(54) SYSTEMS AND METHODS TO MAINTAIN STABILITY OF FUEL FLOW IN GAS TURBINE ENGINES

(71) Applicant: GENERAL ELECTRIC COMPANY, Schenectady, NY (US)

(72) Inventors: Christopher Lavern Stammen, Acworth, GA (US); Huan Van Ho, Sugar Land, TX (US); Ronald Frederick Tyree, Richmond, TX (US); Christopher Don Kelbert, Spruce Grove (CA)

(73) Assignee: GENERAL ELECTRIC COMPANY, Schenectady, NY (US)

(21) Appl. No.: 14/145,790

(22) Filed: Dec. 31, 2013

(51) Int. Cl. F02C 9/46; F23R 3/28

(52) U.S. Cl. CPC F02C 9/46; F23R 3/28

(57) ABSTRACT

A system includes a gas turbine comprising a compressor section, combustor section, and a turbine section. The system further includes a first fuel line and a second fuel line coupled to the gas turbine. The system also includes a feed compressor disposed along the first fuel line upstream of the gas turbine. The feed compressor is configured to pressurize the first fuel provided to the gas turbine. Further, the system includes fuel flow maintenance system configured to provide a pressurized fuel to the first fuel line upstream of the feed compressor in response to an interruption in a flow of the first fuel along the first fuel line to the gas turbine that triggers a transition from the first fuel in the first fuel line to the second fuel in the second fuel line.

### BACKGROUND

The subject matter disclosed herein relates to gas turbine systems, and more particularly systems and methods to maintain stability of a fuel flow in gas turbine systems.

Gas turbine engines include one or more combustors that combust a fuel with oxidant (e.g., air) to generate hot combustion gases, which drive one or more turbine stages of a turbine. Each turbine combustor may include one or more fuel nozzles to inject fuel into a combustion region within the respective combustor. The flame temperature, emissions levels (e.g., nitrogen oxides, sulfur oxides, carbon monoxide, carbon dioxide, and particulate matter), combustion dynamics, and other characteristics of combustion are largely impacted by the fuel flow to each combustor. Furthermore, the fuel flow can vary the output of the gas turbine engine, which in turn affects the load (e.g., electrical generator) driven by the gas turbine engine and thermal exhaust (temperature and flow) energy. Unfortunately, the gas turbine engine may experience one or more destabilizing events in the fuel flow. For example, the gas turbine engine may experience an undesired decrease in the fuel flow, interruption in the fuel flow, or other instability in the fuel flow. Accordingly, as discussed below, it may be desirable to provide a rapid response to such instabilities in the fuel flow, thereby improving the overall operation and stability of the gas turbine engine.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a gas turbine comprising a compressor section, combustor section, and a turbine section. The system further includes a first fuel line coupled to the gas turbine, such that the first fuel line is configured to provide a first fuel to the gas turbine, and a second fuel line coupled to the gas turbine, such that the second fuel line is configured to provide a second fuel to the gas turbine. The system also includes a feed compressor disposed along the first fuel line upstream of the gas turbine. The feed compressor is configured to pressurize the first fuel provided to the gas turbine. Further, the system includes a fuel flow maintenance system coupled to the first fuel line both upstream and downstream of the feed compressor. The fuel flow maintenance system is configured to provide a pressurized fuel to the first fuel line upstream of the feed compressor in response to an interruption in a flow of the first fuel along the first fuel line to the gas turbine that triggers a transition from the first fuel in the first fuel line to the second fuel in the second fuel line.

In a second embodiment, a method includes receiving, via a controller, a first signal indicative of an interruption of a flow of a first fuel along a first fuel line to a gas turbine. The interruption disrupts a steady state of combustion within the gas turbine system. The method further includes transitioning from the first fuel in the first fuel line to a second fuel in the second fuel line in response to the interruption and routing a pressurized fuel stored in a fuel flow maintenance system to the first fuel line during the transition from the first fuel line to the second fuel line. The fuel flow maintenance system is coupled to the first fuel line both upstream and downstream of a feed compressor fluidly coupled to and disposed upstream of the gas turbine.

In a third embodiment, a system includes a fuel flow maintenance system and a controller. The fuel flow maintenance system is configured to be coupled to a first fuel line coupled to a gas turbine, where the first fuel line is configured to provide a first fuel to the gas turbine. The fuel flow maintenance system is configured to couple to the first fuel line both upstream and downstream of a feed compressor disposed upstream of the gas turbine, and the fuel flow maintenance system is configured to provide a pressurized fuel to the first fuel line upstream of the feed compressor in response to an interruption in a flow of the first fuel that triggers a transition from the first fuel in the first fuel line to a second fuel in the second fuel line. The system includes a controller coupled to the fuel flow maintenance system and configured to regulate providing the pressurized fuel to the first fuel line in response to the interruption and during the transition.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic of an embodiment of a gas turbine system having a compressor, a turbine, a primary fuel circuit, a secondary fuel circuit, and a fuel maintenance system;

FIG. 2 is a schematic of an embodiment of a gas turbine system of FIG. 1 including a fuel maintenance system having a head tank, a plurality of valves, and a plurality of sensors; and

FIG. 3 is a flow diagram illustrating an embodiment of a method by which a fuel maintenance system responds to an interrupted fuel flow to the gas turbine system of FIG. 1.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments are directed towards systems and methods for a fuel maintenance system (e.g., a fuel stabilizing system) configured to provide a pressurized fuel to a gas turbine system in response to an interruption of the primary fuel supply (e.g., first fuel supply, first fuel line, etc.) to the gas turbine system. In general, when fuel flow from the primary fuel supply to the gas turbine system is interrupted, the immediate loss of primary fuel flow may trigger a transition from the primary fuel supply to a secondary fuel supply (e.g., second fuel supply, second fuel line, etc.). However, in certain circumstances, the transition from the primary fuel supply to the secondary fuel supply may lead to instability in power output that may force the gas turbine system off the grid. Further, the rapid transition from the primary fuel supply to the secondary fuel supply may cause undesired events in a combustor of the gas turbine system, such as, for example, a flame out, a turbine trip, excessively high temperatures, high emissions, and so forth. Accordingly, it may be desirable to provide a fuel maintenance system configured to provide a pressurized fuel in response to the interruption in fuel flow of the primary fuel supply to the gas turbine. In particular, the fuel maintenance system provides a pressurized fuel that compensates for the amount of primary fuel lost until the transition from the primary fuel supply to the secondary fuel supply is complete and the power output of the gas turbine system is operationally stable.

The fuel maintenance system is coupled to a primary fuel line coupled to the gas turbine system. A feed compressor that provides a pressurized primary fuel to the gas turbine system is disposed along the primary fuel line. The fuel maintenance system is coupled to the fuel line upstream and downstream of a feed compressor of the gas turbine system to form the recirculation loop. For example, the fuel maintenance system provides a pressurized fuel to the primary fuel line upstream of the feed compressor upon identification of the interruption. Further, the fuel maintenance system receives pressurized fuel downstream of the feed compressor when the fuel maintenance system needs to be resupplied with the pressurized fuel. In particular, the recirculation loop includes a head tank configured to store a pressurized fuel until an interruption in the fuel flow to the primary gas supply is identified, at which time the stored pressurized fuel may be used to continue operation of the gas turbine system until transition to the secondary fuel supply is complete. In some embodiments, the pressurized fuel may be entirely composed of, or may be additionally supplemented with, a supplemental fuel. The supplemental fuel may be a blended fuel of 2, 3, 4, 5, 6, or more fuels (e.g., a mixture of a natural gas with an inert gas, such as nitrogen gas) with a composition similar to a composition of the primary fuel.

Further, the fuel maintenance system includes a plurality of valves and sensors communicatively coupled to a controller (e.g., a computer controller having a processor, memory, and executable instructions). The controller may be configured to operate the valves to regulate providing the pressurized fuel to the primary fuel line in response to the interruption, resupply the head tank with pressurized fuel, to generally control the blending of the supplemental fuel, and to generally control the blending of the supplemental fuel with the pressurized fuel. The controller may additionally be configured to receive feedback from one or more sensors disposed along the gas turbine system, and may use the feedback received to regulate the fuel flow maintenance system and/or to regulate the transition between the primary fuel supply and the secondary fuel supply.

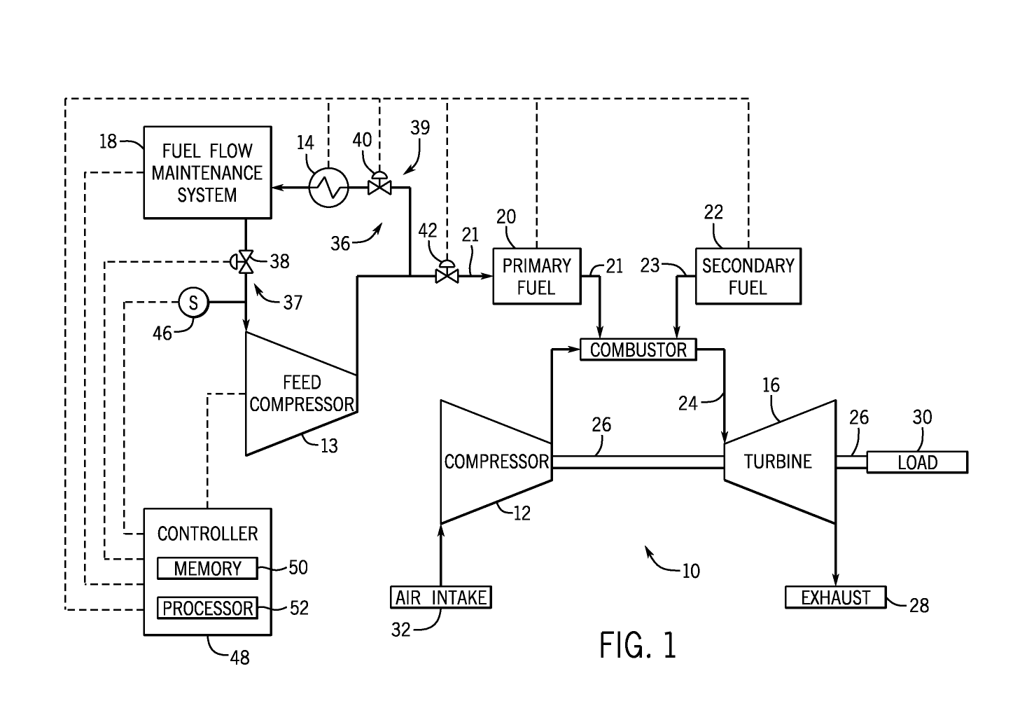

FIG. 1 is a schematic of an embodiment of a gas turbine system 10 having a compressor 12, a feed compressor 13, a turbine combustor 14, a turbine 16, and a fuel flow maintenance system 18 (e.g., fuel flow stabilizing system). The turbine combustor 14 may receive a liquid fuel, a gas fuel (e.g., natural gas), a process gas fuel, and/or a blended fuel (e.g., a mixture of natural gas and process gas) from a primary fuel supply 20 (e.g., a first fuel) and/or a secondary fuel supply 22 (e.g., a second fuel). For example, in certain embodiments the primary fuel 20 may be a process gas derived through refinery or chemical processes (e.g., petrochemical refinery processes) upstream of the gas turbine system 10. Examples of process gases used in the primary fuel 20 may include a blast furnace gas, a coke oven gas, a refinery flue gas, a synthetic gas generated as a result of a refinery or chemical process, and so forth. The secondary fuel 22 may be a blend of various fuel sources, such as for example, a blend of a natural gas and/or a nitrogen gas, a blend of natural gas and/or process gas, and so forth.

The turbine combustor 14 may have multiple fuel nozzles configured to receive the primary fuel 20 from a primary fuel line 21 and/or the secondary fuel 22 from a secondary fuel line 23. The turbine combustor 14 ignites and combusts an oxidant-fuel mixture (e.g., an air-fuel mixture), and then passes the resulting hot pressurized combustion gasses 24 into the turbine 16. Turbine blades within the turbine 16 are coupled to a shaft 26 of the gas turbine system 10, which may also be coupled to several other components throughout the turbine system 10. As the combustion gases 24 flow against and between the turbine blades of the turbine 16, the turbine 16 is driven into rotation, which causes the shaft 26 to rotate. Eventually, the combustion gases 24 exit the turbine system 10 via an exhaust 28. Further, in the illustrated embodiment, the shaft 26 is coupled to a load 30, which is powered via the rotation of the shaft 26. The load 30 may be any suitable device that generates power via the rotational output of the turbine system 10, such as an electrical generator, a propeller of an airplane, or other load.

The compressor 12 of the gas turbine system 10 includes compressor blades. The compressor blades within the compressor 12 are coupled to the shaft 26, and will rotate as the shaft 26 is driven to rotate by the turbine 16, as discussed above. As the compressor blades rotate within the compressor 12, the compressor 12 compresses air (or any suitable oxidant) received from an air intake 32 to produce pressurized air 34. The pressurized air 34 is then fed into the fuel nozzles of the combustors 14. The fuel nozzles mix the pressurized air 34 and the primary fuel 20 and/or the secondary fuel 22 to produce a suitable mixture ratio for combustion, e.g., a combustion that causes the fuel to more completely burn, so as not to waste fuel or cause excess emissions.

In particular, the fuel flow maintenance system 18 may be coupled both upstream and downstream of the feed compressor 13 to form a recirculation loop 36. The fuel flow maintenance system 18 is configured to provide a pressurized fuel upstream of the primary fuel line 21 in response to an interruption event. An interruption event may result when a fuel flow of the primary fuel 20 along the primary fuel line 21 to the gas turbine system 10 is temporarily hindered or stalled (e.g., temporary flow decrease, reduction in fuel flow, fluctuation in fuel flow, or other instabilities). Generally, the gas turbine system 10 may compensate for an interruption event by increasing fuel flow of the secondary fuel 22 from the secondary fuel line 23 (e.g., transitioning from the primary fuel 20 to the secondary fuel 22). However, in certain circumstances, the transition response may not occur fast enough to continue normal operation of the combustor 14 and the turbine 16 and to keep the load 30 (e.g., electrical generator) or the energy of the exhaust 28 stable. Accordingly, the fuel flow maintenance system 18 may be configured to provide the pressurized fuel (e.g., pressurized primary fuel) during the transition between the primary fuel 20 and the secondary fuel 22. In particular, the amount of pressurized fuel provided by the fuel flow maintenance system 18 is enough to compensate for the amount of primary fuel lost during the interruption event.

The fuel flow maintenance system 18 stores the pressurized fuel to be used in the event of an interruption of fuel flow from the primary fuel line 21. The volume of pressurized fuel stored in the fuel flow maintenance system 18 may be enough to feed the gas turbine system 10 for any suitable time duration (e.g., seconds, minutes, hours, etc.). For example, the time duration may be a range of minutes (e.g., approximately 1-10 minutes, 10-15 minutes, 15-20 minutes, 20-30 minutes, or more than 30 minutes), a range of seconds (e.g., approximately 1-10 seconds, 10-15 seconds, 15-20 seconds, 20-40 seconds, or more than 40 seconds), or a range of hours (1-5 hours, 5-10 hours, 10-15 hours, 15-20 hours, 20-24 hours, etc.). In particular, the fuel flow maintenance system 18 stores a pressurized fuel compressed by the feed compressor 13. The pressure of the pressurized fuel is substantially similar to the pressure at which the compressor 12 outputs the pressurized air. For example, if the feed compressor 13 outputs pressurized air 34 at approximately 250 psi, the feed compressor 13 additionally compresses the pressurized fuel to approximately 250 psi and the fuel flow maintenance system 18 stores the pressurized fuel at approximately 250 psi.

As mentioned above, the fuel flow maintenance system 18 may be coupled both upstream and downstream of the feed compressor 13 to form a recirculation loop 36. For example, the fuel flow maintenance system 18 includes an outlet coupled to a first portion 37 of the recirculation loop 36 at an outlet valve 38. The outlet valve 38 is disposed upstream of the feed compressor 13. Further, the fuel flow maintenance system 18 includes an inlet coupled to a second portion 39 of the recirculation loop 36 at an inlet valve 40 (e.g., check valve 40). The inlet valve 40 is disposed downstream of the feed compressor 13. At the detection of the interruption event where fuel flow from the primary fuel line 21 is interrupted, a fuel valve 42 disposed downstream of the feed compressor 13 is configured to open. Further, the outlet valve 38 opens to release the pressurized fuel stored within the fuel flow maintenance system 18, while the inlet valve 40 closes to block a backflow of the pressurized fuel back into the fuel flow maintenance system 18. In certain embodiments, the fuel valve 42 may be open in the standby mode of the system 10, so that upon detection of the interruption event, the outlet valve 38 opens to release the pressurized fuel directly into the primary fuel line 21. In this manner, the recirculation loop 36 routes the pressurized fuel stored within the fuel flow maintenance system 18 to the primary fuel 20. At the completion of the transition of fuel sources (e.g., from the primary fuel line 21 to the secondary fuel line 23), the fuel valve 42 is configured to close, and the inlet valve 40 is configured to open and resupply the fuel flow maintenance system 18 with pressurized fuel. In certain embodiments, a cooler 44 may be disposed on the recirculation loop 36 between the fuel flow maintenance system 18 (e.g., feed compressor 13) and the inlet valve 40 and may be configured to cool the pressurized fuel before it is stored within the fuel flow maintenance system 18.

In certain embodiments, a plurality of sensors 46 may be disposed within the gas turbine system 10, such as along the recirculation loop 36, within the fuel flow maintenance system 18, along the primary fuel 20, and the secondary fuel 22. The sensors 46 may be any suitable type of sensor, such as, for example, a flow control sensor, a pressure control sensor, a flow ratio control sensor, optical sensors, mechanical sensors, pressure sensors, temperature sensors, vibration sensors, or electrical sensors. Particularly, the sensors 46 may be communicatively coupled to a controller 48 having a memory 50 and a processer 52 (e.g., non-transitory computer readable medium stores instructions or code to be executed by the processor to control the controller 48). The controller 48 may be configured to receive feedback from the one or more sensors 46 disposed along the gas turbine system 10, and may use the feedback received to regulate the fuel flow maintenance system 18 and/or to regulate the transition between the primary fuel 20 and the secondary fuel 22. For example, in some embodiments, the feedback received from the one or more sensors 46 may include pressures, temperatures, information on flow, vibrations, flame temperatures, emission levels, fuel flow at combustors, and so forth.

Additionally, the plurality of valves disposed along the recirculation loop 36 (e.g., outlet valve 38, inlet valve 40, the fuel valve 42, the feed compressor 13, etc.) may be coupled to the controller 48. For example, the controller 48 may be coupled to connectors on the valves, such as electric pneumatic or hydraulic actuators, which in turn operate to open and close the valves. The controller 48 may be configured to operate the valves to regulate providing the pressurized fuel to the primary fuel 20 in response to the interruption event, to resupply the fuel flow maintenance system 18 with pressurized fuel, and to generally control the flow of the pressurized fuel through the recirculation loop 36. In some embodiments, the controller 48 may be configured to supply the fuel maintenance system 18 with a supplemental fuel to supplement the pressurized fuel. Accordingly, the fuel maintenance system 18 may rapidly respond to compensate for the interruption of the primary fuel flow from the primary fuel line 21 to the gas turbine system 10.

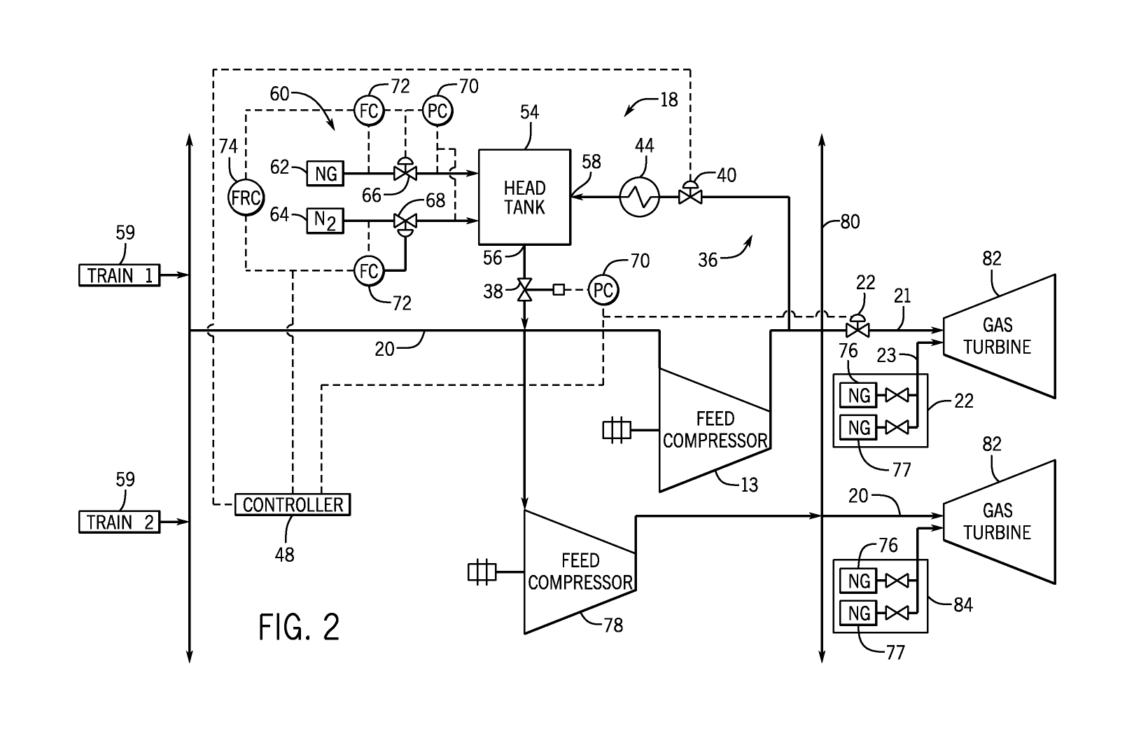

FIG. 2 is a schematic of an embodiment of the gas turbine system 10 of FIG. 1 including the fuel maintenance system 18 having a head tank 54 and a plurality of sensors 46. The head tank 54 is configured to store a pressurized fuel at substantially the discharge pressure of the feed compressor 13. In the event of a interruption of the fuel flow from the primary fuel line 21 (e.g., loss of fuel feed event or incident), the head tank 54 is configured to release its contents into the primary fuel line 21 upstream of the feed compressor 13 suction. The head tank 54 comprises an outlet 56 leading to an outlet valve 38 disposed on a portion of the recirculation loop 36 located upstream of the feed compressor 13. Further, the head tank 54 comprises an inlet 58 disposed on a portion of the recirculation loop 36 downstream of the feed compressor 13.

In particular, the head tank 54 includes a fuel blending skid 60 configured to blend one or more different fuel sources to create a supplemental fuel that may be used to supplement the pressurized fuel. As noted above, the pressurized fuel may be entirely composed of the supplemental fuel, or the pressurized fuel may be supplemented with the supplemental fuel. In such embodiments, the mixture of the pressurized fuel and the supplemental fuel may be additionally pressurized to a suitable pressure (e.g., discharge pressure of the compressor 12). In the illustrated embodiment, the fuel blending skid 60 includes a natural gas fuel source 62 and an inert gas, such as, for example, a nitrogen gas 64. It should be noted that in other embodiments, the fuel blending skid 60 may be configured to blend any suitable types of fuel and inert gases, such as fuel sources with different energy values (e.g., lower heating values or higher heating values). The controller 48 may be configured to regulate the blending by controlling a natural gas valve 66 and a nitrogen gas valve 68. In particular, the controller 48 may use feedback from one or more sensors 46 to regulate the blending within the fuel blending skid 60 to create a supplemental fuel (e.g., a blended fuel) with a composition similar to the composition of the primary fuel 20 at the time of the interruption event (e.g., creating a supplemental fuel with a heating value substantially similar to the heating value of the primary fuel 20). For example, the controller 48 may receive feedback information from a pressure control sensor 70, a flow control sensor 72, and/or a flow ratio control sensor 74. The pressure control sensor 70 may regulate the pressure of each fuel supply source (e.g., natural gas supply 62) and inert gas (e.g., nitrogen gas supply 64) to match the pressure of the primary fuel 20 at the time of the interruption (e.g., feed loss) event. Similarly, the flow control sensors 72 may be configured to regulate the flow of each fuel supply source and inert gas supply. The flow ratio control sensor 74 may be configured to regulate the ratio of the natural gas supply 62 to the nitrogen gas supply 64 so that the composition of the supplemental fuel (e.g., blended fuel) may be similar to the primary fuel 20 at the time of the interruption event. As discussed above, the primary fuel 20 from the primary fuel line 21 may be a process gas derived through a variety of processes, such as, for example, refinery or chemical processes (e.g., petrochemical refinery processes) upstream of the gas turbine system 10. As illustrated, each train 59 (e.g., train 1, train 2, etc.) may supply a primary gas (e.g., a process gas, a syngas, etc.) from a different upstream processing technique. Accordingly, the controller 48 may be configured to regulate the blending within the blending skid 60 to create a supplemental fuel similar in composition to the primary gas received.

Indeed, the controller 48 may use feedback from the sensors 46 to regulate blending and create a supplemental fuel of a given composition and heating value so that the gas turbine system 10 operates stably. The controller 48 may accomplish this by creating a supplemental fuel with a “Modified Wobbe Index” (MWI) that is within an allowable range of the primary fuel 20 (e.g., within approximately 5%, 6%, 7%, 8%, 9%, 10%, 11%, 12%, 13%, and so forth). The MWI is a relative measure of the energy input to the combustor 14 at a fixed pressure ratio and determines the ability of the fuel conditioning and injection system to accommodate the variations in composition and heating value. If the variation of the supplemental fuel when compared to the primary fuel 20 is outside the allowable range, the controller 48 is configured to regulate the blending within the fuel blending skid 60 (e.g., by controlling the ratio of the natural gas supply 62 to the nitrogen gas supply 64) to achieve an appropriate MWI. The blended fuel, with an appropriate MWI, enters the recirculation loop 36 through the head tank 54, and cycles through the recirculation loop 36 until it is appropriately pressurized by the compressor 12. Accordingly, the pressurized fuel stored within head tank 54 may be a blended supplemental fuel with a composition substantially similar to the composition of the primary fuel within the primary fuel line 21.

As discussed above, at the detection of the interruption event where fuel flow of the primary or first fuel from the primary fuel line 21 is interrupted, the fuel valve 42 disposed upstream of the primary fuel line 21 is configured to open to allow the supplemental fuel to be routed to the combustor 22 of the turbine 16. In some embodiments, the fuel valve 42 is configured to remain open during operation of the system 10. Further, the outlet valve 38 opens to release the blended pressurized fuel stored within the head tank 54, while the inlet valve 40 closes to block a backflow of the blended pressurized fuel back into the head tank 54. In this manner, the recirculation loop 36 routes the blended pressurized fuel stored within the head tank 54 to the primary fuel line 21. At the completion of the transition of fuel sources (e.g., from the primary fuel 20 to the secondary fuel 22), the inlet valve 40 is configured to open. In the illustrated embodiment, the secondary fuel 22 includes a natural gas supply 76 and a nitrogen gas supply 77 that may be blended before routed to the gas turbine system 10 via the secondary fuel line 23. The natural gas supply 76 and the nitrogen gas supply 77 may each include valves configured to open to the blended secondary fuel 22 mixture. In certain embodiments, the controller 48 may additionally be configured to identify the amount of fuel stored within the head tank 54, so that when an empty head tank 54 is identified, the controller 48 releases the natural gas valve 66 and/or the nitrogen gas valve 68 and resupplies the head tank 54 with the blended fuel. In some embodiments, the pressurized fuel may be provided by pressurizing a portion of the primary fuel 22 configured to be stored within the head tank 54. Further, once the blended fuel enters the recirculation loop 36, it may circulate within the loop 36 and the feed compressor 13 may pressurize the blended fuel to a suitable pressure (e.g., an outlet pressure of the feed compressor 13) before storing the blended pressurized fuel within the head tank 54.

In particular, the head tank 54 may be configured to supply a blended pressurized fuel to a plurality of feed compressors (e.g., feed compressors 13 and 78) and gas turbines 82. In the illustrated embodiment, when the head tank 54 outlet valve 38 is opened, the contents of the head tank 54 (e.g., pressurized primary, supplemental fuel, secondary fuel 22, or a combination thereof) may be supplied to the feed compressor 13 and the feed compressor 78. Further, in certain embodiments the feed compressor 78 may be coupled to the recirculation loop 36 (not illustrated). Each feed compressor within the system 10 (e.g., feed compressor 13 and feed compressor 78) may be coupled to pressurized fuel line 80 that leads to a plurality of gas turbines 82. For example, feed compressor 78 may be configured to operate with gas turbine 82, which additionally may have its own secondary fuel line 84.

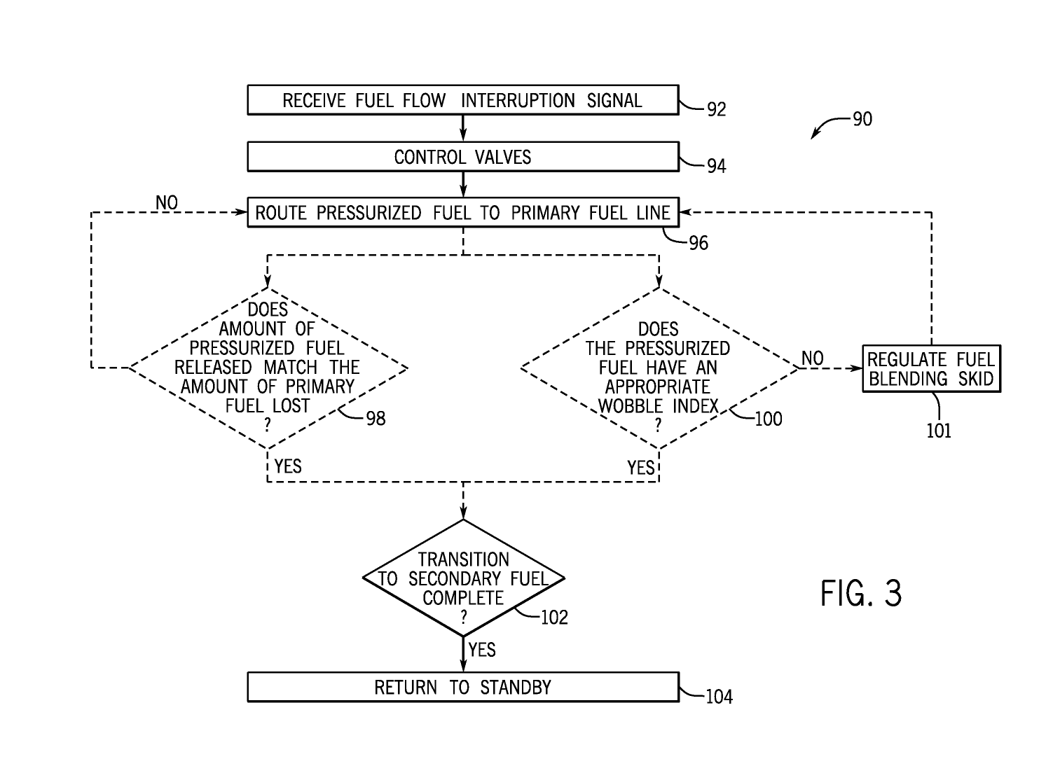

FIG. 3 is a flow diagram illustrating an embodiment of a method 90 by which the fuel maintenance system 18 responds to an interrupted fuel flow to the gas turbine system 10 of FIG. 1. The method 90 begins with the controller 48 receiving a fuel flow interruption signal (block 92) from one or more sensors 46 disposed within the gas turbine system 10 (e.g., along the recirculation loop 36, within the fuel flow maintenance system 18, along the primary fuel 20, and the secondary fuel 22). In some embodiments, the interrupted fuel flow is an interruption of the primary fuel from the primary fuel 20 to the combustor 14 of the gas turbine 82. The method 90 further includes controlling a plurality of valves via the controller 48 to initiate a rapid response to the interrupted fuel flow (block 94). For example, upon detection of the interruption event where fuel flow from the primary fuel 20 is interrupted, the pressurized fuel is routed into the primary fuel line 21 and into the combustor 14. Further, the outlet valve 38 opens to release the pressurized fuel stored within the head tank 54, while the inlet valve 40 closes to prevent a backflow of the pressurized fuel back into the head tank 54. In this manner, regulation of the valves disposed along the recirculation loop 36 routes the pressurized fuel stored within the head tank 54 to the primary fuel 20 (block 96).

In some embodiments, the controller 48 may predict a fuel flow interruption based on feedback received from the one or more sensors 46 disposed within the system 10. For example, historical information, computer models, and/or trend information received and/or processed from sensor 46 data may be used by the controller 48 to predict or anticipate a problem within the system 10, such as a fuel flow interruption. Further, the controller 48 may monitor operational parameters that are suggestive or predictive of an upcoming problem (e.g., fuel flow interruption) within the system 10. In such embodiments, the controller 48 may be configured to trigger the fuel flow maintenance system 18 to operate in anticipation of an interruption event.

In certain embodiments, the method 90 includes determining whether the amount of pressurized fuel released from the head tank 54 and into the primary fuel 20 matches the amount of primary fuel lost during the interruption event (block 98). Indeed, the fuel maintenance system 18 is configured to provide a pressurized fuel that compensates (both in flow volume and composition) for the amount of primary fuel lost until the transition from the primary fuel 20 to the secondary fuel supply 22 is complete. If the amount of pressurized fuel is not enough to sufficiently compensate the system 10 for stable operation, an additional amount of pressurized fuel is routed from the head tank 54 to the primary fuel 20. Further, in some embodiments, the method 90 includes determining if the pressurized fuel has an appropriate MWI. As noted above, the fuel flow maintenance system is configured to blend a supplemental fuel with a composition substantially similar to the composition of the primary fuel lost during the interruption event to further supplement the pressurized fuel. The pressurized fuel may be entirely composed of the primary fuel 20, or may be a mixture of the pressurized primary fuel 20 with the newly blended supplemental fuel. In certain embodiments, if the MWI of the pressurized fuel is not within an acceptable range, such as, for example, within 1%, 2%, 3%, 4%, 5%, 6%, 7%, 8%, 9%, 10% or more variation of the composition of the primary fuel, the controller 48 is configured to regulate the blending of the blending skid 60 to modify the MWI of the supplemental fuel by changing the blend ratios of the fuels supplied to the blending skid 60 (block 101). In such embodiments, the modified blend of supplemental fuel may then enter the recirculation loop 36 to be mixed into the pressurized fuel, and pressurized to a suitable amount before being routed from the recirculation loop 36 and into the primary fuel 20.

The method 90 further includes determining if the transition from the primary fuel 20 to the secondary fuel 22 is complete (block 102). As discussed in detail above, the fuel flow maintenance system 18 is configured to supply a pressurized fuel to compensate for the amount of primary fuel lost until the secondary fuel 22 can take over fuel supply to the gas turbine. Finally, upon successfully supplying the gas turbine during the transition from the primary fuel 20 to the secondary fuel 22, the controller 48 is configured to regulate the plurality of valves disposed through the gas turbine system 10 to return the fuel flow maintenance system 18 back to a standby position. For example, at the completion of the transition of fuel sources (e.g., from the primary fuel 20 to the secondary fuel 22), the inlet valve 40 is configured to open. In this manner, the pressurized fuel is allowed to circulate through the recirculation loop 36, and may be stored in the head tank of the fuel flow maintenance system 10 during the standby position (block 104).

Technical effects of the invention include the fuel maintenance system 18 that is configured to provide a pressurized fuel to the primary fuel 20 in response to an interruption of the primary fuel supply to the gas turbine system 10. In particular, the fuel maintenance system 18 includes a head tank 54 disposed along a recirculation loop 36 and configured to store the pressurized fuel until an interruption event is identified or predicted. The recirculation loop 36 may be coupled to the primary fuel line 21 upstream and downstream of the feed compressor 13, and includes a plurality of valves that may be controlled via the controller 48 to regulate the flow of the pressurized fuel to the primary fuel 20. Further, the fuel maintenance system 18 includes a fuel blending skid 60 controlled via the controller 48 (e.g., in response to feedback from the one or more sensors 46), that is configured to blend one or more fuels to achieve a supplemental fuel composition that is similar (e.g., flow rate, composition, etc.) to the primary fuel lost during the interruption event to supplement the pressurized fuel.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a gas turbine comprising a compressor section, a combustor section, and a turbine section;
a first fuel line coupled to the combustor section, wherein the first fuel line is configured to provide a first fuel to the combustor section;
a second fuel line coupled to the combustor section, wherein the second fuel line is configured to provide a second fuel to the combustor section;
a feed compressor disposed along the first fuel line upstream of the combustor section, wherein the feed compressor is configured to pressurize the first fuel provided to the combustor section;
a fuel flow maintenance system coupled to the first fuel line both upstream and downstream of the feed compressor, wherein the fuel flow maintenance system is configured to provide a pressurized fuel to the first fuel line upstream of the feed compressor in response to an interruption in a flow of the first fuel along the first fuel line to the combustor section that triggers a transition from the first fuel in the first fuel line to the second fuel in the second fuel line.

2. The system of claim 1, wherein the fuel flow maintenance system is configured to provide the pressurized fuel to the first fuel during the transition from the first fuel to the second fuel.

3. The system of claim 1, wherein the fuel flow maintenance system comprises a head tank configured to store the pressurized fuel.

4. The system of claim 3, wherein the fuel flow maintenance system comprises a recirculation loop with the first fuel line coupled both upstream and downstream of the feed compressor, wherein the head tank is disposed along the recirculation loop.

5. The system of claim 4, wherein the head tank comprises an outlet coupled to a first portion of the recirculation loop upstream of the feed compressor and an inlet coupled to a second portion of the recirculation loop downstream of the feed compressor.

6. The system of claim 5, wherein the fuel flow maintenance system comprises a first valve disposed between the outlet and the first fuel line, and the first valve is configured to open to provide the pressurized fuel to the first fuel line upon the interruption and to close upon completion of the transition.

7. The system of claim 6, wherein the fuel flow maintenance system comprises a second valve disposed between the inlet and the feed compressor, and the second valve is configured to close upon the interruption and to open upon completion of the transition to resupply pressurized fuel to the head tank.

8. The system of claim 7, comprising a controller coupled to the fuel flow maintenance system, wherein the controller is coupled to the first and second valves and is configured to regulate providing the pressurized fuel to the first fuel line in response to the interruption and to resupply the pressurized fuel to the head tank.

9. The system of claim 8, wherein the controller is configured to control the transition from the first fuel to the second fuel.

10. The system of claim 9, comprising sensors disposed at the gas turbine, along the first fuel line, along the second fuel line, and within the fuel flow maintenance system, wherein the controller is configured to receive feedback from the sensors to regulate the fuel flow maintenance system and to regulate the transition between the first fuel and the second fuel.

11. The system of claim 1, wherein the pressurized fuel is at a pressure substantially equivalent to the discharge pressure of the feed compressor.

12. The system of claim 1, wherein the pressurized fuel comprises a pressurized first fuel.

13. The system of claim 1, wherein the fuel flow maintenance system is configured to supplement the pressurized fuel with a mixture of the second fuel and the nitrogen, wherein a ratio of the second fuel to the nitrogen in the mixture provides a wobbe index similar to the first fuel.

14. A method, comprising:
receiving, via a controller, a first signal indicative of an interruption of a flow of a first fuel along a first fuel line to a combustor of a gas turbine, wherein the interruption disrupts a steady state of combustion within the gas turbine system;
transitioning from the first fuel in the first fuel line to a second fuel in the second fuel line in response to the interruption; and
routing a pressurized fuel stored in a fuel flow maintenance system to the first fuel line during the transition from the first fuel line to the second fuel line, wherein the fuel flow maintenance system is coupled to the first fuel line both upstream and downstream of a feed compressor fluidly coupled to and disposed upstream of the combustor.

15. The method of claim 14, comprising opening an outlet valve of the fuel flow maintenance system to provide the pressurized fuel to the first fuel line upon the interruption, and closing the outlet valve upon completion of the transition.

16. The method of claim 14, comprising closing an inlet valve of the fuel flow maintenance system upon the interruption, and opening the inlet valve to resupply the fuel flow maintenance system with pressurized fuel upon completion of the transition.

17. The method of claim 14, comprising adjusting a blend ratio of the pressurized fuel, via the controller, to match a composition of the first fuel.

18. A system, comprising:
a fuel flow maintenance system configured to couple to a first fuel line coupled to a combustor of a gas turbine, wherein the first fuel line is configured to provide a first fuel to the combustor, wherein the fuel flow maintenance system is configured to couple to the first fuel line both upstream and downstream of a feed compressor disposed upstream of the combustor, and wherein the fuel flow maintenance system is configured to provide a pressurized fuel to the first fuel line upstream of the feed compressor in response to an interruption in a flow of the first fuel that triggers a transition from the first fuel in the first fuel line to a second fuel in a second fuel line; and
a controller coupled to the fuel flow maintenance system and configured to:
regulate providing the pressurized fuel to the first fuel line in response to the interruption and during the transition.

19. The system of claim 18, wherein the controller is configured to receive feedback from a plurality of sensors to regulate the fuel flow maintenance system and to regulate the transition between the first fuel and the second fuel.

20. The system of claim 18, wherein the controller is configured to adjust a blend ration of a supplemental fuel that supplements the pressurized fuel provided by the fuel flow maintenance system so that the supplemental fuel has a modified wobbe index substantially the same as the first fuel, wherein the supplemental fuel comprises a blend of the second fuel and nitrogen.
